(19) United States
(12) Patent Application Publication
(10) Pub. No.: US 2008/0294560 A1
(43) Pub. Date: Nov. 27, 2008

(54) Method of storing content

(75) Inventors: Silke Holtmanns, Klaukkala (FI); Pekka Laitinen, Helsinki (FI); Tao Haukka, Oulu (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/802,387

(22) Filed: May 22, 2007

(51) Int. Cl. H04L 9/00

(52) U.S. Cl. 705/51

(57) ABSTRACT

A method comprising receiving at a user equipment encrypted content. The content is stored in said user equipment in an encrypted form. At least one key for decryption of said stored encrypted content is stored in the user equipment.

### BACKGROUND OF THE INVENTION

1. Field of the Invention

The present invention relates to a method of storing content and in particular but not exclusively to storing broadcast content which may be encrypted.

2. Description of the Related Art

A communication system is a facility that enables communication between two or more entities such as user terminal equipment and/or networks entities and other nodes associated with the communication system. The communication may comprise, for example, communication of voice, electronic mail (email), text messages, data, multimedia and so on.

The communication may be provided via fixed line and/or wireless communication interfaces. A feature of the wireless communication systems is that they provide mobility for the users thereof. Examples of communication systems providing wireless communication include the public land mobile network (PLMN) and wireless data networks such a Wireless Local Area Network (WLAN).

A type of the PLMN is a cellular communication system. In a cellular system the user equipment may access the communication network via access entities known as radio access networks. The skilled person knows the basic operational principles and elements of a cellular network and these are therefore not explained herein in any greater detail. It is sufficient to note that a cell can be defined as a radio access entity that is served by one or several base stations (BS) serving user equipment (UE) via a wireless interface between the base station and the user equipment. Examples of the cellular networks include networks that are based on access systems such as the CDMA (Code Division Multiple Access), WCDMA (Wide-band CDMA), TDMA (Time Division Multiple Access), FDMA (Frequency Division Multiple Access), or SDMA (Space Division Multiple Access) and hybrids thereof.

A communication system typically operates in accordance with a given standard or specification which sets out what the various elements of the system are permitted to do and how that should be achieved. For example, the standard or specification may define if the user, or more precisely, user equipment is provided with a circuit switched service or a packet switched service or both. Communication protocols and/or parameters which shall be used for the connection are also typically defined. For example, the manner how communication shall be implemented between the user equipment and the elements of the communication network is typically based on a predefined communication protocol. In other words, a specific set of “rules” on which the communication can be based on needs to be defined to enable the user equipment to communicate via the communication system.

Standardization of the so called multicast/broadcast multimedia service (MBMS) has been proposed by the third Generation Partnership Project (3GPP). More specific details of the MBMS may be found, for example, in the 3GPP technical specification TS22.146 or 3GPP TS25.346 ‘Introduction of the Multimedia Broadcast Multicast Service (MBMS) in the Radio Access Network’.

There are other mobile broadcast and streaming standards, such as DVB-H, OMA BCAST (Open Mobile Alliance broadcast), 3GPP MBMS (Multimedia Broadcast Multicast Service), and 3GPP2 BCMCS (Broadcast and Multicast Services). These standards are run on the assumption that the user watches the content when it is broadcasted/multicast or even unicast.

Part of the OMA BCAST Smartcard profile mechanism relies on the 3GPP MBMS security, which in turn relies on the Generic Bootstrapping Architecture (GBA) of 3GPP. Other parts of OMA_BCAST Smartcard Profile mechanism make direct use of GBA.

However the known arrangements have a problem. This arises in situations when a user would like to view broadcast data after it has been transmitted. Say you have a meeting and your favourite football club is playing, you want to watch the game slightly later on the bus home on your phone, but then the data is no longer broadcasted. This requires the broadcast data to be saved.

An operator wants to make sure that the data can only be viewed, when a smart card of a given individual is present, because the broadcast was coming from the individual's network.

A content provider wants to make sure that the data can not be transferred and read out easily, so storage in unencrypted format of the content is generally not acceptable.

Digi-Boxes and video recorders store the data without encryption.

ISMACryp (“ISMA 1.0 Encryption and Authentication, Version 1.1”, which can be found at page http://www.isma.tv) uses the following approach: when receiving the encrypted stream, the encrypted stream can be recorded by concatenated the payload part into a MP4 file format.

Open Mobile Alliance Broadcast (BCAST) group has defined ISMACryp file playback on section 6.7 of the Service and Content Protection for Mobile Broadcast Services 1.0″ by OMA.

The terminal or user equipment has to request the old MBMS Service Keys (MSK) key from service provider. To do this the user equipment has to go online to request the key and that the service provider has to keep the key available and online. This requires a point-to-point MBMS Traffic Key (MTK) transmission which is undesirable.

MBMS specification (3GPP TS 33.246) states that the keys are to be deleted when redundant (i.e. expired) and therefore recording is not supported by this standard.

### SUMMARY OF THE INVENTION

According to a first aspect, there is a provided a method comprising: receiving at a user equipment encrypted content; storing in said user equipment said content in an encrypted form; and storing in said user equipment at least one key for decryption of said stored encrypted content.

According to a second aspect there is provided apparatus comprising: a receiver configured to receive encrypted content; storage configured to store said content in an encrypted form and at least one key for decryption of said stored encrypted content.

According to a third aspect, there is provided apparatus comprising: means for receiving encrypted content; means for storing said content in an encrypted form and at least one key for decryption of said stored encrypted content.

According to a fourth aspect, there is provided a computer readable medium having computer executable components configured to: cause received content to be stored in an encrypted form with at least one key for decryption of said stored encrypted content.

### BRIEF DESCRIPTION OF THE DRAWINGS

For better understanding of the present invention, reference will now be made by way of example only to the accompanying drawings in which:

FIG. 1 shows a communication system wherein the present invention may be embodied;

FIG. 2 schematically shows a first embodiment; and

FIG. 3 schematically shows another embodiment.

### DETAILED DESCRIPTION OF THE PREFERRED EMBODIMENTS

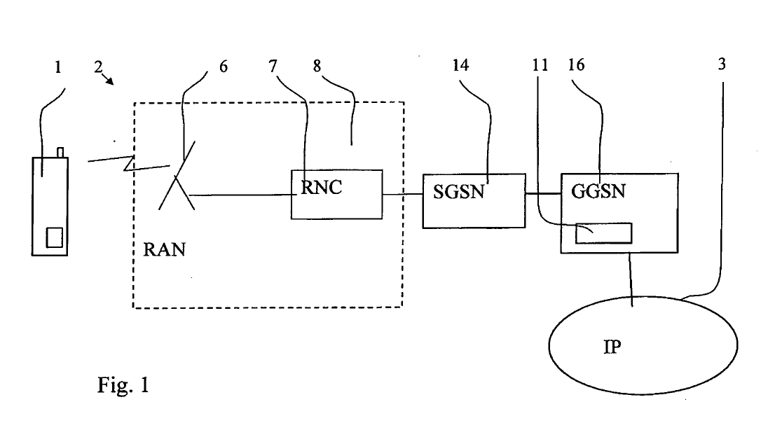

Reference is first made to FIG. 1 which shows a communication network wherein the present invention may be employed. The shown communication system is capable of providing wireless data transportation services for a user equipment 1 by means of a public land mobile network (PLMN) 2.

The skilled person is familiar with the features and operation of typical mobile user equipment. Thus these do not need any further explanation. It is sufficient to note that the user may use the mobile user equipment 1 for performing tasks such as for making and receiving phone calls, for receiving content from the network and for experiencing the content presented by means of the display and/or the speaker and for interactive correspondence with another party. The user equipment 1 wanting to join a service context may be provided with appropriate means such as data processing means, memory means, an antenna for wirelessly receiving and transmitting signals from and to base stations, a display for displaying images and other visual information for the user of the mobile user equipment, speaker means, and control buttons and so on. However, it shall be appreciated that the user equipment or the various elements of a user equipment as such do not form an essential feature of the present invention. The user equipment may be arranged only to receive broadcast or multicast content in some embodiments of the invention.

The content may take any suitable form such as video content, audio content and data content as well as combinations of two or more different types of content.

The elements of the PLMN network 2 will also be discussed briefly first to clarify the operation of a typical PLMN. A mobile station or other appropriate user equipment 1 is arranged to communicate via the air interface with a transceiver element 6 of the radio access network 8 of the PLMN. It should be appreciated that the term mobile station is intended to cover any suitable type of wireless user equipment, such as mobile telephones, portable data processing devices or portable web browsers.

The transceiver element 6 will be referenced to by the term base station. The term base station will be used in this document to encompass all elements which transmit to and/or receive from wireless stations or the like via the air interface. The base station 6 is controlled by a radio network controller RNC 7.

The radio network controller RNC and the base station belong to the radio access network RAN 8 (e.g. a UTRAN: UMTS Terrestrial RAN). It should be appreciated that a UMTS radio access network is typically provided with more than one RNC, and that each radio network controller is arranged generally to control more than one base station 6 although only one base station is shown in FIG. 1.

The radio access network 8 is connected to the core network of the PLMN system. Typically the connection would be provided to a SGSN (serving GPRS support node) 14 on an Iu interface. The SGSN 14 is for functions such as keeping track of the mobile station's location and performing security functions and access control. The SGSN 14 is connected to a GGSN (gateway GPRS support node) 16. The GGSN 16 provides interworking with other communication networks 3. In other words, the GGSN 16 acts as a gateway between the PLMN network 2 and the other networks.

FIG. 1 shows a data network, and more particularly, an IP based data network 3 as an example of such other network. However, it should be appreciated that embodiments of the invention may be applied to other types of communication arrangements as well. Therefore, although not shown, the communication system 2 of FIG. 1 may also be connected to conventional telecommunication networks, such as to a GSM based cellular public land mobile network (PLMN) or to a public switched telephone network (PSTN). The various networks may be interconnected to each other via appropriate interfaces and/or gateways.

Another proposal for the 3GPP is that, when joining occurs, signaling also from the SGSN to the RNC occurs to inform the RNC about the joined user equipment. But even this signaling would not create the bearer between the SGSN and RNC (i.e. MBMS RAB).

The core network elements 14 and/or 16 store information about mobile user equipment joining/leaving an MBMS service. In FIG. 1 the required information of the service context and the user equipment joined is stored in memory 11 of the GGSN 16. However, it shall be appreciated that in certain implementations the information may be stored either alternatively or also in a memory of the SGSN 14 (not shown for clarity). For each activated MBMS service context, the network elements are supposed to store an “MBMS service context”. This information may include parameters that relate to the type of the PDP (=MBMS service context), the MBMS service ID (e.g. IP multicast address), Quality of Service (QoS) attributes, access point name (APN), GTP tunneling such as the receiving IP address and TEID both for signaling and data, the joined user equipment, charging, and so on.

In some embodiments of the invention, a secure storage of broadcast keys and their identifiers is provided. This enables the user to playback encrypted content also after the actual broadcast. Embodiments of the invention may achieve this without compromising a security policy/rights permission associated with the content. In one embodiment the content protection is bound to the smart card of the operator and hence to the subscription.

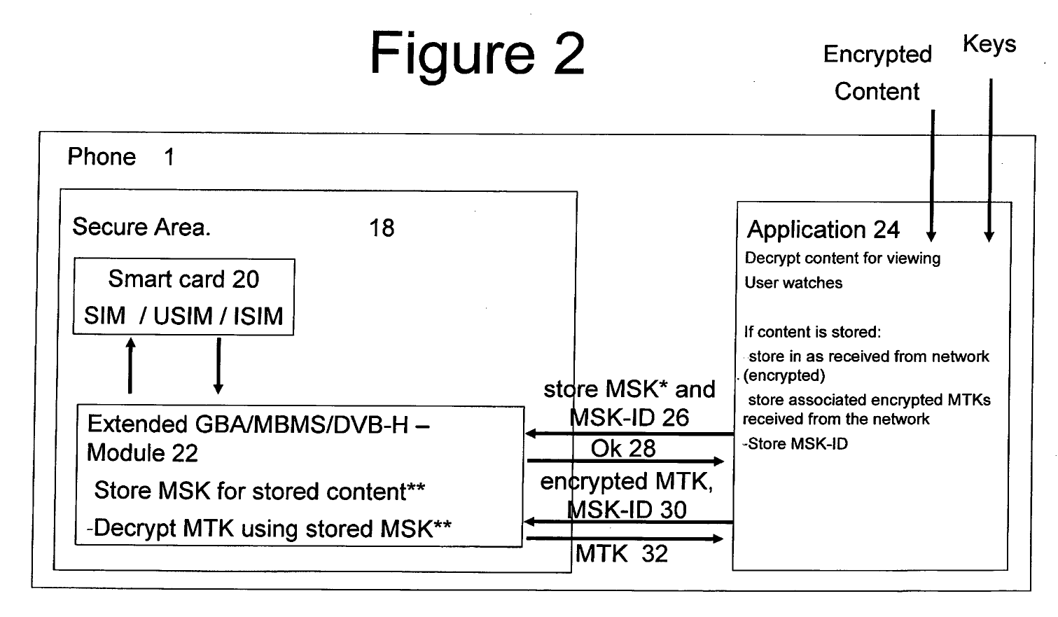

Reference is made to FIG. 2 which schematically shows a first embodiment of the invention. The user equipment 1 comprises a secure area 18. The area is secured in any appropriate way, for example by the operating system OS. In this secure area 18 is a smart card 20. The smart card can take any suitable form and may be a SIM (subscribe identity module, a USIM (user services identity module) or ISIM (IM services identity module).

The secure area also has a module 22. The nature of the module is dependent on the standard or standards with which the user equipment can be used. For example the module may be a GBA (generic bootstrapping module), a MBMS module or a DVB-H module. In some embodiments separate modules are provided for each different standard supported by the user equipment. In other embodiments a single module will support a plurality of different standards. A user equipment may only support a single standard. In yet another embodiment the module is in a smart card. In some embodiments the decryption and video decoding is done by a special dedicated video or similar integrated circuit.

The module is arranged to store MSK (MBMS service keys) for stored content. The MTK (MBMS traffic key) is decrypted using the stored MSK.

The module 22 is arranged to communicate with an application 24 which is on the user equipment. The application 24 is arranged to receive encrypted content and the associated keys. The application is arranged to decrypt the content so the user is able to view the content as it is received. The application 24 is also arranged to store the content. In one embodiment of the invention the content is stored in the form in which it is received from the network, that is in an encrypted form. Additionally, the application is arranged to store the associated encrypted MTKs received from the network. Finally the application is arranged to store the MSK ID (MSK identifier), that is the identity of the MSK. The application may thus comprise processor capacity and memory capacity.

The application thus stores the content as it was received from the network (i.e., encrypted with MTKs). The keys may come together with the content or in a separate key stream. The application indicates to the module 22 that takes care of the GBA key management in the terminal that a given MSK and the MSK-ID needs to be stored as associated content is being stored. This is indicated by reference number 26. Depending on the standard either the MSK is sent for storage (GBA_ME, GBA) or indicates the need for MSK storage (GBA_U).

This is acknowledged by the module as indicated by reference number 28.

The application stores the encrypted MTKs itself with the content or in the alternative the module stores them. Note, as the MTK is encrypted with the MSK, the user can only get the content if he is able to decrypt the MTK. For this the MSK is required.

During playback, the application sends the encrypted MTK and the MSK ID to the modules as indicated by reference number 30. The MSK storage and MTK decryption can take place in the smart card, the module or another entity of the user equipment. The storage and decryption may involve different entities. In response thereto, the application gets decrypted or plaintext MTKs from the module 22. This is indicated by reference number 32.

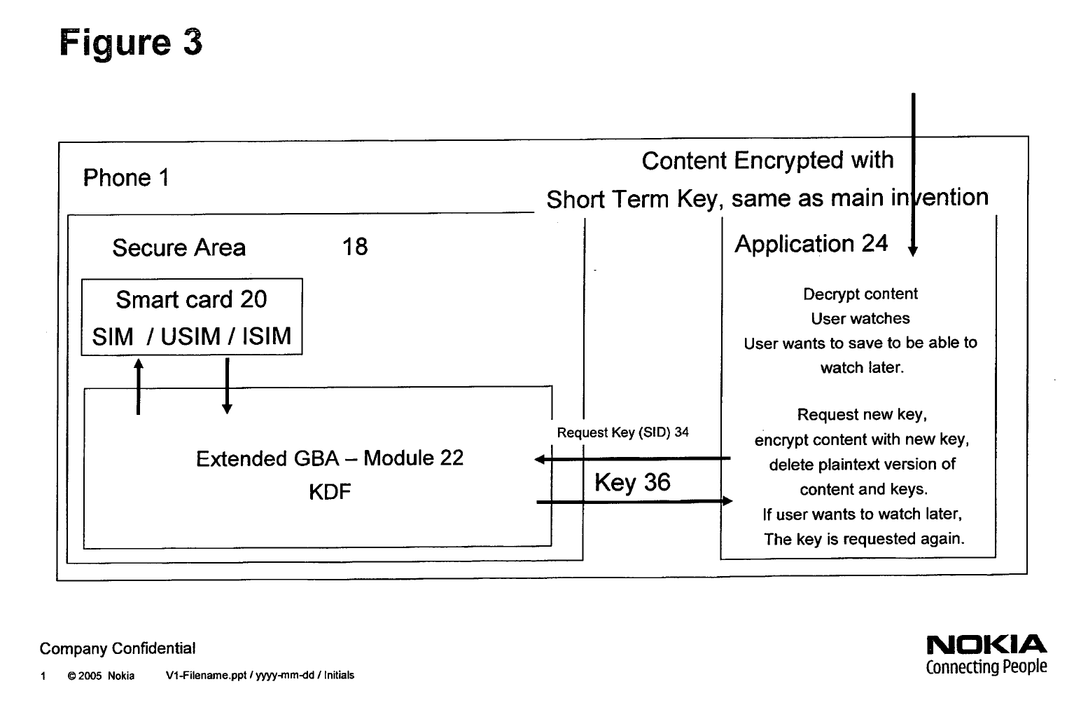

Reference is now made to a second embodiment of the invention which is shown schematically in FIG. 3. In this embodiment the application 24 and the secure area 18 are both provided on the phone 1. In this case the decrypted content is encrypted once again with the local created key. This is fundamentally unlimited playback since there is no key lifetime associated to this local key. Accordingly there is no MTK stream stored.

In particular the application decrypts the content. The user is able to watch the content. Additionally or alternatively the content can be stored. The application is arranged to request a key from the module as indicated by reference number 34. The key derivation format KDF is based on the smart card credentials and the smart card identity. It should be appreciated that the KDF can take any other suitable format and may be or derived from the smart card ID or the IMEI International Mobile Equipment Identity.

The module sends the key to the application as indicated by reference 36. The application uses the new key to encrypt the content. The plaintext version of the content and the keys, that is the decrypted originally received content, is deleted. If the user wishes to watch the content, the application requests the key from the module. Using the key, the application can decrypt the stored content.

The key may be from GBA server. This may put MBMS keys into GBA management. Since the key is locally created and GBA has no policy control, in terms of policy control this may be regarded as being equivalent to the case where key is created by MBMS client itself.

There are various approaches and variations which can be used in alternative embodiments.

In one approach there is unlimited playback support and the content playback is validity free.

The content playback validity binds with MSK without limitation. The MTK is stored in encrypted format.

Alternatively, the MTK is stored in plain (proprietary) format and no MSK needed.

In yet another embodiment of the invention, the content is encrypted with a local key (e.g. first MTK used for this content) and no MTK stored.

Embodiment of the invention may provide limited playback support.

In one embodiment the content playback validity binds with MSK lifetime. MTK is stored in encrypted format.

In another embodiment the content playback validity binds with constraints unsatisfied (e.g. playback counter reaches 0). MSK is removed when counter reaches 0, meaning MSK lifetime is extended till there is no content using it.

In another embodiment the content playback validity binds with a local key with limited key lifetime and unsatisfied constraints. This is as shown in the embodiment of FIG. 2.

The MSK key may be stored in the smart card and requested/deleted when appropriate. The encrypted MTKs may also be decrypted in the smart card.

If the user deletes the content, the keys MSK and encrypted MTK may also to be deleted to free the space. In the alternative, the MSK linked with no content should be removed. This is because the same MSK can be linked with a plurality of content.

The storage of the MSK can use directly the Multimedia Internet KEYing (MIKEY) protocol message (RFC 3830).

In some embodiments no key lifetime information is stored, so the MSK is valid indefinitely.

Some embodiments of the invention may have one or more of the following advantages: 1) the content is secure, 2) playback without online connectivity is possible, 3) re-use of existing functionalities to make implementation and integration easy, 4) bind the content protection to the subscription of the device, 5) comply with indication in ESG (electronic service guide) and Traffic Key stream and 6) no need to change the smart card.

It should be appreciated that whilst embodiments of the present invention have been described in relation to mobile stations, embodiments of the present invention are applicable to any other suitable type of user equipment.

It should be appreciated that while the embodiments of the invention are described in the context of a UMTS (Universal Mobile Telecommunications System) and a GPRS (General Packet radio Service) and Internet Protocol (IP) networks, the embodiments of the present invention are applicable to any network, independent of transport layer technology, and independent of the architecture (connection-oriented or connectionless) of the system. Thus the invention is also applicable to, in addition of the code division multiple access (CDMA) any other access techniques including frequency division multiple access (FDMA), time division multiple access (TDMA) and space division multiple access (SDMA) as well as any hybrids thereof. For example, MBMS may also be provided in connection with 2G networks such as the GSM. In this case, the RAN nodes would be called different names. For example, the RNC is referred to as the Base Station controller (BSC). The interface between the RAN and the CN is called Gb instead of Iu.

It is also noted herein that while the above describes exemplifying embodiments of the invention, there are several variations and modifications which may be made to the disclosed solution without departing from the scope of the present invention as defined in the appended claims.

What is claimed is:

1. A method comprising:
receiving at a user equipment encrypted content;
storing in said user equipment said content in an encrypted form; and
storing in said user equipment at least one key for decryption of said stored encrypted content.

2. A method as claimed in claim 1, comprising storing said received encrypted content.

3. A method as claimed in claim 1, comprising receiving at least one key.

4. A method as claimed in claim 1, comprising receiving at least one key with said encrypted content.

5. A method as claimed in claim 1, comprising receiving at least one key separately from said encrypted content.

6. A method as claimed in claim 1 comprising storing said at least one key in a smart card of said user equipment.

7. A method as claimed in claim 1, wherein said at least one key is encrypted.

8. A method as claimed in claim 7, comprising storing at least one further key for decryption of said encrypted key.

9. A method as claimed in claim 1 comprising receiving at an application of said user equipment encrypted content;

10. A method as claimed in claim 9, comprising storing in said application said content in the encrypted form in which the content is received and an encrypted key for the decryption of said encrypted content.

11. A method as claimed in claim 8, wherein said further key is stored in one of a smart card and an application.

12. A method as claimed in claim 8, comprising decrypting said encrypted key with said further key and sending said decrypted key to an application.

13. A method as claimed in claim 8, comprising sending said further key to a smart card from an application, when said encrypted content is being stored.

14. A method as claimed in claim 8, comprising decryption said encrypted key with said further key when playback of said stored content is required.

15. A method as claimed in claim 1, comprising deleting said at least one key.

16. A method as claimed in claim 15, wherein said key is deleted when all content associated with said key has been one of deleted or played back.20.

17. A method as claimed in claim 16, comprising reencrypting said content with a key of said user device.

18. A method as claimed in claim 17, comprising reencrypting said content based on a smart card specific key.

19. A method claim as claimed in claim 1, comprising receiving said encrypted content as broadcast encrypted content.

20. Apparatus comprising:
a receiver configured to receive encrypted content;
storage configured to store said content in an encrypted form and at least one key for decryption of said stored encrypted content.

21. Apparatus as claimed in claim 20, wherein said storage at least partially comprises a smart card configured to store said at least one key.

22. Apparatus as claimed in claim 20 comprising an application configured to receive said encrypted content

23. Apparatus as claimed in claim 22, wherein said application is configured to store said content in the encrypted form in which the content is received and said at least one key, in encrypted form, for the decryption of said encrypted content.

24. Apparatus as claimed in claim 23, wherein said storage is configured to store a further key for the decryption of said encrypted key.

25. Apparatus as claimed in claim 23 wherein said further key is stored in one of a smart card and said application.

26. Apparatus as claimed in claim 22, which is configured such that said further key is sent to a smart card of said apparatus from an application, when said encrypted content is being stored.

27. Apparatus as claimed in claim 20, said apparatus comprising user equipment.

28. Apparatus comprising
means for receiving encrypted content;
means for storing said content in an encrypted form and at least one key for decryption of said stored encrypted content.

29. A computer readable medium having computer executable components configured to:
cause received content to be stored in an encrypted form with at least one key for decryption of said stored encrypted content
